(19) United States
(12) Patent Application Publication
(10) Pub. No.: US 2021/0305844 A1
(43) Pub. Date: Sep. 30, 2021

(54) WIRELESS POWER RECEPTION DEVICE, AND CONTROL METHOD THEREFOR

(71) Applicant: SAMSUNG ELECTRONICS CO., LTD., Suwon-si, Gyeonggi-do (KR)

(72) Inventors: Shinwook CHOI, Suwon-si, Gyeonggi-do (KR); Jeongil KANG, Suwon-si, Gyeonggi-do (KR); Moonyoung KIM, Suwon-si, Gyeonggi-do (KR)

(21) Appl. No.: 17/259,351

(22) PCT Filed: Jul. 31, 2019
(86) PCT No.: PCT/KR2019/009504

§ 371 Date: Jan. 11, 2021

(30) Foreign Application Priority Data
Jul. 31, 2018 (KR) 10-2018-0089477

(51) Int. Cl. H02J 50/12; H02J 50/00; H02J 50/80; H02J 7/02; H04B 5/00

(52) U.S. Cl. CPC H02J 50/12; H02J 50/005; H02J 2207/20; H02J 7/02; H04B 5/0037; H02J 50/80

(57) ABSTRACT

A wireless power reception device is disclosed. The wireless power reception device comprises: a reception coil which receives power from a wireless power transmission device; a rectifier which rectifies the received power; an output terminal which outputs the rectified power to an external electronic device; a first switch which is provided between the rectifier and the output terminal; and a controller which identifies the intensity of the rectified power, turns on the first switch so as for the received power to be supplied to the output terminal if the intensity of the rectified power falls within a preset range, and turns off the first switch so as to block the supply of the rectified power to the output terminal if the intensity of the rectified power does not fall within the preset range.

### TECHNICAL FIELD

This disclosure relates to a wireless power reception device and a control method therefor. More particularly, this disclosure relates to a wireless power reception device including a switch and a control method therefor.

### BACKGROUND ART

Wireless power transfer may refer to a technology capable of transmitting power without a wire. Wireless power transfer is also called Wi-power in comparison with a Wi-Fi technology, which enables access to Internet wirelessly anytime and anywhere.

Wireless power transmission and reception method includes an inductive power transfer system (IPTS) method which is used for smartphone wireless charging, a coupled magnetic resonance system (CMRS) of which use for an electric car, a high-speed train, or the like is being pushed forward, and a remote microwave mode in which a technology to be used in the aerospace power generation is under development, or the like.

Recently, there is a move to mitigate discomfort of a wire thanks to the development of electronic technology, and to apply wireless power transmission technology to various types of electronic devices in an interior aspect.

Most of the related-art electronic devices have an inconvenience and restriction that the electronic devices are operable only when power is provided by wire, as wireless power transmission technology is not grafted. There is a problem in that wireless power is hard to be stably transmitted to various types of electronic devices.

### DISCLOSURE

### Technical Problem

The disclosure has been made to solve the above-described problems, and an object of the disclosure is to provide a wireless power eception device which receives power wirelessly and provides the received power to an external electronic device and a control method therefor.

The disclosure provides a wireless power reception device which protects internal configurations of the wireless power reception device or an external electronic device by controlling a switch or a control method therefor.

### Technical Solution

According to an embodiment, a wireless power reception device includes a reception coil configured to receive power from a wireless power transmission device, a rectifier configured to rectify the received power, an output terminal configured to output the rectified power to an external electronic device, a first switch provided between the rectifier and the output terminal, and a controller configured to identify the rectified power, turn on the first switch so as for the rectified power to be supplied to the output terminal based on intensity of the rectified power falling within a preset range, and turn off the first switch so as to block the supply of the rectified power to the output terminal based on the intensity of the rectified power not falling within the preset range.

The wireless power reception device includes a second switch provided between the rectifier and the first switch and a load serially connected to the second switch, and the controller may turn off the second switch so as to block the supply of the rectified power to the load based on the intensity of the rectified power falling within the preset range, and turn on the second switch so as for the rectified power to be supplied to the load based on the intensity of the rectified power not falling within the preset range.

The wireless power reception device includes a third switch provided between the reception coil and the rectifier, and the controller may identify whether the received power is greater than or equal to a preset threshold value, turn off the third switch so as to block supply of the received power to the rectifier based on the received power being greater than or equal to the preset threshold range, and turn on the third switch so as to supply the received power to the rectifier based on the received power being less than the preset threshold value.

The preset threshold value may be identified based on an internal pressure of a capacitor included in the rectifier.

The wireless power reception device includes a communication interface, and the controller may control the communication interface to transmit the information of the preset range to the wireless power transmission device based on the intensity of the rectified power not falling within the preset range.

The wireless power reception device may include a converter configured to convert the rectified power to a preset intensity.

The output terminal may be in a form in which wired connection to a power terminal of the external electronic device is available.

The output terminal may be in a form of a connector that is connected to a power terminal of the external electronic device.

According to an embodiment, a control method of a wireless power reception device comprising a reception coil, a rectifier, an output terminal, and a first switch provided between the rectifier and the output terminal includes receiving, by the reception coil, power from the wireless power transmission device; rectifying the received power by the rectifier; identifying whether the intensity of the rectified power falls within a preset range; and outputting the rectified power to an external electronic device by the output terminal, and the identifying may include turning on the first switch so as for the rectified power to be supplied to the output terminal based on the intensity of the rectified power falling within a preset range; and turning off the first switch so as to block the supply of the rectified power to the output terminal based on the intensity of the rectified power not falling within the preset range.

The wireless power reception device includes a second switch provided between the rectifier and the first switch and a load serially connected to the second switch, and the identifying may include turning off the second switch so as to block the supply of the rectified power to the load based on the intensity of the rectified power falling within the preset range; and turning on the second switch so as for the rectified power to be supplied to the load based on the intensity of the rectified power not falling within the preset range.

The wireless power reception device may include a third switch provided between the reception coil and the rectifier, and the identifying may include identifying whether the received power is greater than or equal to a preset threshold value; turning off the third switch so as to block supply of the received power to the rectifier based on the received power being greater than or equal to the preset threshold range; and turning on the third switch so as to supply the received power to the rectifier based on the received power being less than the preset threshold value.

The preset threshold value may be identified based on an internal pressure of a capacitor included in the rectifier.

The method may include transmitting information of the preset range to the wireless power transmission device based on the intensity of the rectified power not falling within the preset range.

The method may include converting the rectified power to a preset intensity.

The output terminal may be in a form that wired connection to a power terminal of the external electronic device is available.

The output terminal may be in a form of a connector that is connected to a power terminal of the external electronic device.

### Effect of Invention

According to various embodiments, even a related-art electronic device which is not applied with wireless power transmission technology may receive power wireless and operate by connecting an additional device in a kit type to an electronic device, thus improving convenience of a user.

### DESCRIPTION OF DRAWINGS

FIG. 1 is a block diagram illustrating a configuration of a wireless electronic transmission device and a reception device according to an embodiment;

FIG. 2 is a circuitry diagram illustrating a specific configuration of the wireless power reception device illustrated in FIG. 1;

FIG. 3 is a block diagram illustrating a configuration of a wireless power reception device according to another embodiment;

FIG. 4 is a circuitry diagram illustrating a specific configuration of the wireless power reception device illustrated in FIG. 3;

FIG. 5 is a block diagram illustrating a configuration of a wireless power reception device according to another embodiment;

FIG. 6 is a circuitry diagram illustrating a specific configuration of the wireless power wireless power reception device of FIG. 5;

FIG. 7 is a diagram illustrating a communication interface according to an embodiment;

FIG. 8 is a diagram illustrating a converter according to an embodiment; and

FIG. 9 is a flowchart illustrating a control method for the wireless power reception device according to an embodiment.

### BEST MODE FOR CARRYING OUT THE INVENTION

### MODE FOR CARRYING OUT THE INVENTION

After terms used in the present specification are briefly described, the present disclosure will be described in detail.

General terms that are currently widely used were selected as terms used in embodiments of the disclosure in consideration of functions in the disclosure, but may be changed depending on the intention of those skilled in the art or a judicial precedent, the emergence of a new technique, and the like. In addition, in a specific case, terms arbitrarily chosen by an applicant may exist. In this case, the meaning of such terms will be mentioned in detail in a corresponding description portion of the disclosure. Therefore, the terms used in embodiments of the disclosure should be defined on the basis of the meaning of the terms and the contents throughout the disclosure rather than simple names of the terms.

Since the disclosure may be variously modified and have several embodiments, specific embodiments of the disclosure will be illustrated in the drawings and be described in detail in the detailed description. However, it is to be understood that the disclosure is not limited to specific exemplary embodiments, but includes all modifications, equivalents, and substitutions without departing from the scope and spirit of the disclosure. When it is decided that a detailed description for the known art related to the disclosure may obscure the gist of the disclosure, the detailed description will be omitted.

Terms ‘first’, ‘second’, and the like, may be used to describe various components, but the components are not to be construed as being limited by the terms. The terms are used only to distinguish one component from another component.

Singular forms are intended to include plural forms unless the context clearly indicates otherwise. It will be further understood that terms “include” or “formed of” used in the present specification specify the presence of features, numerals, steps, operations, components, parts, or combinations thereof mentioned in the present specification, but do not preclude the presence or addition of one or more other features, numerals, steps, operations, components, parts, or combinations thereof.

In exemplary embodiments of the present disclosure, a ‘module’ or a ‘˜er/˜or’ may perform at least one function or operation, and be implemented by hardware or software or be implemented by a combination of hardware and software. In addition, a plurality of ‘modules’ or a plurality of ‘˜ers/˜ors’ may be integrated in at least one module and be implemented by at least one processor (not illustrated) except for a ‘module’ or a ‘˜er/or’ that needs to be implemented by specific hardware.

Hereinafter, embodiments of the disclosure will be described in detail with reference to the accompanying drawings so that those skilled in the art to which the disclosure pertains may easily practice the disclosure. However, the disclosure may be implemented in various different forms and is not limited to embodiments described herein. In addition, in the drawings, portions unrelated to the description will be omitted to obviously describe the disclosure, and similar portions will be denoted by similar reference numerals throughout the specification.

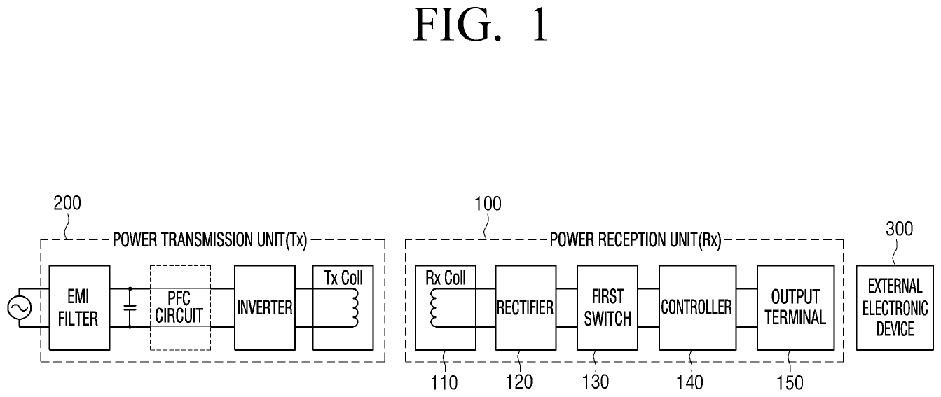

FIG. 1 is a block diagram illustrating a configuration of a wireless electronic transmission device and a reception device according to an embodiment.

As illustrated in FIG. 1, a wireless power transmission and reception system according to an embodiment includes a wireless power reception device 100 and a wireless power transmission device 200.

The power supply line of the wireless power transmission device 200 may be connected to a power outlet which provides a commercial power (e.g., 90 to 264 V), and the wireless power transmission device 200 may transmit the commercial power to the wireless power reception device 100.

The wireless power reception device 100 may receive (generate voltage by induced electromotive force) power transmitted from the wireless power transmission device 200 wirelessly and provide the power to an external electronic device 300.

Referring to FIG. 1, the wireless power transmission device 200 may include an electromagnetic interference (EMI) filter, a power factor correction (PFC) circuit, an inverter, a transmission coil, or the like. The EMI filter may rectify and smooth the inputted commercial power to output direct current (DC) voltage in a preset level. A half wave or a full wave rectifier circuit may be used for the rectification, and the capacitor may be connected to the output terminal of the rectifier circuit in parallel for smoothing.

A power factor correction (PFC) circuit may reduce a phase difference between a direct current (DC) voltage and a direct current through the EMI filter. Therefore, the power efficiency may be increased by offsetting the reactive power.

The inverter may convert the DC current outputted from the PFC circuit to the AC current to convert the DC current to AC current to be used by a transmission coil (Tx coil). Accordingly, the transmission coil may transmit electromagnetic energy to a wireless power reception device 100.

Referring to FIG. 1, the wireless power reception device 100 may include a reception coil (Rx coil) 110, a rectifier 120, a first switch 130, a controller 140, and an output terminal 150.

An induced electromotive force may be generated by a current flowing through a transmission coil or a voltage applied to a transmission coil of the wireless power transmission device 200, and the induced electromotive force has a unit of voltage.

The reception coil 110 of the wireless power reception device 100 may receive electromagnetic energy from a transmission coil. According to an example, the reception coil 110 may receive power through a magnetic coupling with a transmission coil.

The rectifier 120 may rectify the power received through the reception coil 110. According to an example, the rectifier 120 may rectify an AC current received in the reception coil 110 to generate a DC current. The rectifier 120 may rectify and smooth the AC voltage provided by the reception coil 110 to convert the AC voltage to a DC voltage.

The first switch 130 may be turned on/off according to the control of the controller 140. When the first switch is turned on, the rectified power may be supplied to the output terminal 150 through the rectifier 120, and when the second switch is turned off, supply of the power rectified through the rectifier 120 to the output terminal 150 may be blocked.

The output terminal 150 may output the rectified power to the external electronic device 300. The output terminal 150 may output power required for driving the external electronic device 300.

According to an embodiment of the present disclosure, the controller 140 may identify whether the intensity of the rectified power falls within a preset range. According to an example, the controller 140 may identify whether the voltage rectified through the rectifier 120 belongs to an effective value of 127 to 373 V_{direct current} √2×90 to √2×264) corresponding to a commercial voltage of 90 to 264V.

According to an embodiment, the controller 140 may supply the rectified power to the output terminal 150 by turning on the first switch 130 when the intensity of the rectified power falls within a preset range. The controller 140 according to another example may block supply of the rectified power to the output terminal 150 by turning off the first switch 130 when the intensity of the rectified power does not fall within a preset range.

The controller 140 may include, for example, and without limitation, one or more among microprocessor, a central processing unit (CPU), a micro controller unit (MCU), a micro processing unit (MPU), a controller, an application processor (AP), a communication processor (CP), an advanced reduced instruction set computing (RISC) machine (ARM) processor, or the like, or may be defined as a corresponding term. The controller 140 may be implemented in a system on chip (SoC) type or a large scale integration (LSI) type which a processing algorithm is built therein or in a field programmable gate array (FPGA) type.

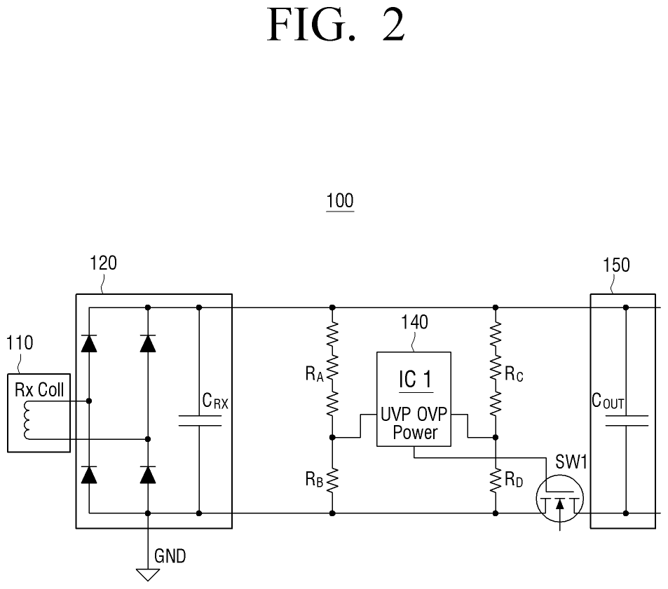

FIG. 2 is a circuitry diagram illustrating a specific configuration of the wireless power reception device illustrated in FIG. 1.

Referring to FIG. 2, the wireless power reception device 100 according to an embodiment of the present disclosure may include the first switch 130. The first switch 130 may be provided between the controller 140 and the output terminal 150.

The circuit diagram shown in FIG. 2 is an embodiment and is not limited thereto, and the first switch 130 may be provided at various locations in the wireless power reception device 100.

The controller 140 may identify whether the power rectified through the rectifier 120 belongs to a preset range.

According to an embodiment, the controller 140 may include information about a preset range. Information about a preset range may be limiting upper and lower limits of the output voltage of the output terminal 150 to protect at least one of the wireless power reception device 100 and the external electronic device 300. Referring to FIG. 2, the controller 140 may obtain an over voltage protection (OVP) and an under voltage protection (UVP) based on information, and may identify whether the rectified voltage belongs to the OVP or UVP.

The controller 140 may turn on the first switch 130 when the rectified voltage falls within a preset range. As the first switch 130 is turned on, the rectified power may be supplied to the output terminal 150. The output terminal 150 may provide power to the external electronic device 300.

According to another example, the controller 140 may turn off the first switch 130 when the rectified voltage does not fall within a preset range. When the first switch 130 is turned off, supply of the rectified power to the output terminal 150 may be blocked. For example, supply of power exceeding a preset range to the external electronic device 300 may be blocked and the external electronic device 300 may be protected.

The external electronic device 300 may be an electronic device that is not able to receive wireless power. For example, the external electronic device 300 may be a related-art electronic device which is connected to a power outlet and is operable as a commercial power supply is supplied.

When the wireless power reception device 100 is connected to the external electronic device 300 to supply power to the external electronic device 300, the external electronic device 300 may receive power from the wireless power transmission device 200 even when the external electronic device 300 is not connected to the power outlet.

According to one embodiment, the external electronic device 300 may operate by receiving wireless power through connection with the wireless power reception device 100 without having to include a wireless power transmission/reception device in the manufacturing step. The output terminal 150 of the wireless power reception device 100 may replace a related-art power outlet.

The wireless power reception device 100 may provide rectified power in a preset range to the external electronic device 300, and may prevent overcurrent, overvoltage, undercurrent, and undervoltage from being supplied to the external electronic device 300.

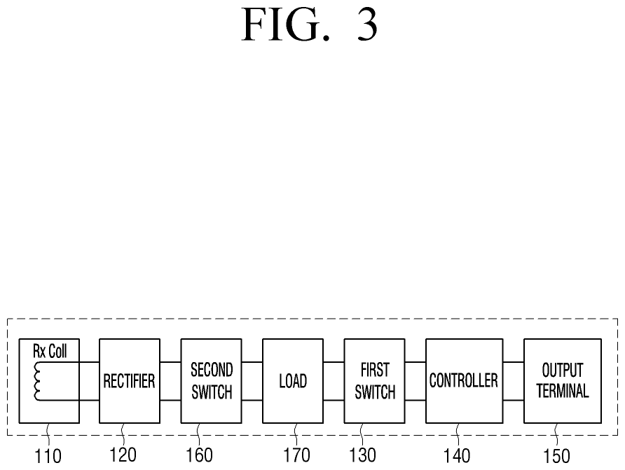

FIG. 3 is a block diagram illustrating a configuration of a wireless power reception device according to another embodiment.

The wireless power reception device 100 according to an embodiment may include a second switch 160 provided between the rectifier 120 and the first switch 130 and a load 170 serially connected to the second switch 160.

The controller 140 according to an embodiment may block supply of the rectified power to the load 170 by turning off the second switch 160 when the intensity of the rectified power falls within a preset range. For example, if the intensity of the rectified power is within a preset range, the first switch 130 may be turned on and the second switch 160 may be turned off to provide the power to the external electronic device 300 through the output terminal 150.

As another example, the controller 140 may turn on the second switch 160 so that rectified power is not supplied to the load 170 when the intensity of the rectified power is not within a preset range.

Since the wireless power reception device 100 has a high voltage gain, the voltage may be increased when the wireless power reception device 100 is unloaded. The rectifier diode included in the wireless power reception device 100 has to have high voltage rating, and the rectifier diode having a high voltage rating has a problem of increase in production costs.

In identifying whether the rectified voltage falls within a preset range by the controller 140, the wireless power reception device 100 may include the load 170 in order to reduce errors and improve accuracy.

The load 170 may be called a dummy resistance, or the like, but it will be called the load 170 for convenience.

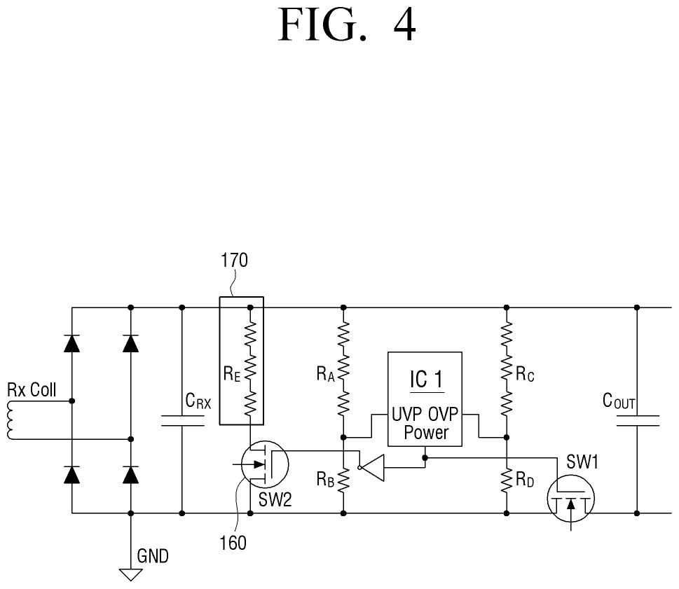

FIG. 4 is a circuitry diagram illustrating a specific configuration of a wireless power reception device illustrated in FIG. 3.

Referring to FIG. 4, the controller 140 may turn off the first switch 130 when the intensity of the rectified power does not fall within a preset range and may turn on the second switch 160. Accordingly, the rectified power may not be not supplied to the output terminal 150 and may be supplied to the load 170. The power-on of the second switch 160 may refer to a closed state of the second switch 160.

The controller 140 may block supply of the rectified power to the load by turning off the first switch 130 if the intensity of the rectified power falls within a preset range. If the rectified power is not supplied to the external electronic device 300 through the output terminal 150, the voltage applied to the internal rectifier diode may increase. This has a problem of causing an error in identifying by the controller 140 whether the intensity of the rectified voltage falls within a preset range and reducing the accuracy. According to an embodiment, the controller 140 may supply the rectified power to the load 170 by turning on the second switch 160 if the intensity of the rectified power falls within a preset range. The rectified power may be consumed by the load 170 other than the rectifier diode in the inside, and an increase in the voltage applied to the rectifier diode may be prevented. In identifying by the controller 140 whether the intensity of the rectified voltage falls within a preset range, error may be reduced and accuracy may be improved.

According to another example, the controller 140 may turn off the second switch 160 when the intensity of the rectified power falls within a preset range and may turn on the first switch 130 to provide the rectified power to the external electronic device 300 through the output terminal 150. The off state of the second switch 160 may refer to the open state of the second switch 160.

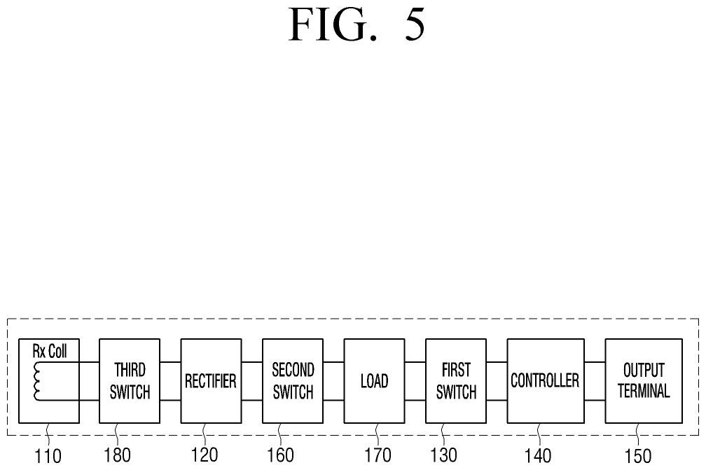

FIG. 5 is a block diagram illustrating a configuration of a wireless power reception device according to another embodiment.

The wireless power reception device 100 according to an embodiment may include a third switch 180 provided between the reception coil 110 and the rectifier 120.

The third switch 180 may be turned on/off according to the control of the controller 140. When the third switch 180 is turned on, the power received through the reception coil 110 may be supplied to the rectifier 120, and when the third switch 180 is turned off, the supply of the power received through the reception coil 110 to the rectifier 120 may be blocked.

The controller 140 according to an embodiment may identify whether the power received through the reception coil 110 is greater than or equal to a preset threshold value. For example, the controller 140 may identify whether the power received through the reception coil 110 is greater than or equal to a preset threshold value before the rectified power is within a preset range. The preset threshold value may be different from an upper limit of a preset range. For example, a preset threshold value may be a high intensity power that causes damage to the circuit in the wireless power reception device 100 and may be associated with an internal pressure (rated voltage) of a capacitor. For example, a preset threshold value may be determined as an internal pressure of the capacitor, and the internal pressure of the capacitor may be about 1.5 times (about 400 V) of an upper limit of a commercial voltage range (e.g., 90 to 264V).

For example, the reception coil 110 of the wireless power reception device 100 may receive a voltage greater than or equal to an upper limit of a commercial voltage range (e.g., 90 to 264V) from the wireless power transmission device 200. The controller 140 may turn off the third switch 180 if the received power is greater than or equal to a preset threshold value and may block supply of the received power to the rectifier 120. If the intensity of the voltage received through the reception coil 110 is identified as being able to cause damage to the internal circuit, the controller 140 may protect the components of the wireless power reception device 100 and the internal circuit by using the third switch 180. The turn-off of the third switch 180 may refer to a state that the third switch 180 is opened.

According to another example, the controller 140, based on the received power being less than a preset threshold value, may provide the received power to the rectifier 120 by turning on the third switch 180. The turn-on of the third switch 180 may refer to a state that the third switch 180 is in a closed state.

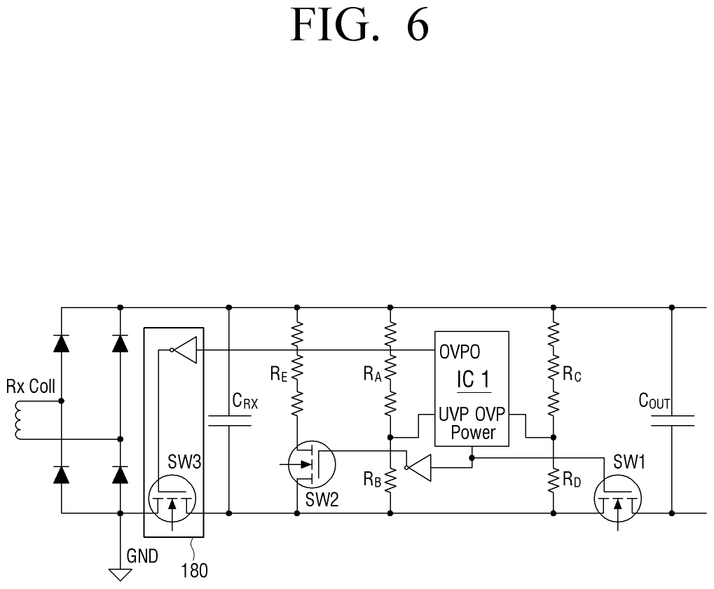

FIG. 6 is a circuitry diagram illustrating a specific configuration of a wireless power wireless power reception device of FIG. 5.

Referring to FIG. 6, the third switch 180 may be disposed between the reception coil 110 and the rectifier 120.

According to an embodiment, the controller 140 may include information about a preset threshold value. The preset threshold value may be limiting of an upper limit of the intensity of the power provided to the rectifier 120 through the reception coil 110 to protect the wireless power reception device 100. Referring to FIG. 6, the controller 140 may obtain a preset threshold value based on the information and may identify whether the intensity of the power received through the reception coil 110 is greater than or equal to a preset threshold value.

According to an embodiment, a preset threshold value may be identified based on the internal pressure of the capacitor included in the rectifier 120. When power greater than or equal to a preset threshold value is received to prevent the rectifier 120 from being damaged as power exceeding the internal pressure of the capacitor included in the rectifier 120 is provided, the rectifier 120 may be protected by using the third switch.

According to an example, an internal voltage (rated voltage) of a capacitor may be in a range of about 1.5 times (about 400 V) of an upper limit of a commercial voltage range (e.g., 90 to 264V). According to an embodiment, the controller 140 may turn off the third switch 180 when a voltage exceeding the internal pressure of the capacitor is received due to a surge voltage, or the like.

According to an embodiment, if the received power is greater than or equal to a preset threshold value, the controller 140 may turn off the third switch 180 to block supply of the received power to the rectifier 120. Accordingly, the rectifier 120, the controller 140, the output terminal 150, and the external electronic device 300 may be protected. The 1.5 times (e.g., 400V) of the upper limit of the commercial voltage range relative to the internal pressure of the capacitor associated with the preset threshold value is merely an embodiment, and various capacitance capacitors may be provided according to the purpose of the manufacturer, and the preset threshold value may be changed.

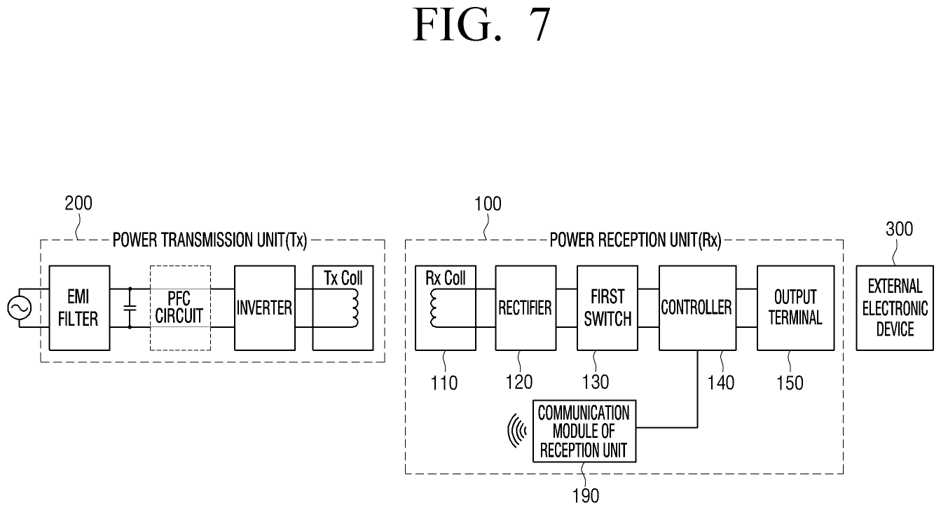

FIG. 7 is a diagram illustrating a communication interface according to an embodiment.

Referring to FIG. 7, the wireless power reception device 100 according to an embodiment may further include a communication interface 190. The communication interface 190 may communicate with a communication interface provided in the wireless power transmission device 200.

According to one embodiment, the wireless power reception device 100 may transmit a control signal, feedback information, or the like, to the wireless power transmission device 200 through the communication interface 190. For example, if the rectified power does not fall within a preset range, the wireless power reception device 100 may transmit information about a preset range through the communication interface 190.

The wireless power transmission device 200 may transmit power of the changed intensity to the reception coil 110 based on the received information.

According to another example, the wireless power reception device 110, when the rectified power does not fall within a preset range, may transmit a signal requesting change of the intensity of power. Accordingly, the intensity of the rectified power may be changed so as to belong to a preset range in the rectifier 120.

According to one embodiment, if the intensity of the power transmitted to the reception coil 110 is greater than or equal to a preset threshold value, the wireless power reception device 100 may transmit a signal requesting that the intensity of the power transmitted by the wireless power transmission device 200 is less than a preset threshold value. A control signal, feedback information, or the like, may be transmitted and received between the wireless power transmission device 200 and the wireless power reception device 100.

The communication interface 190 according to an embodiment may include a communication module such as Wifi, Zigbee, Bluetooth, or the like. For example, communication can be performed with the wireless power transmission device 200 through a Bluetooth Low Energy (BLE) technology. However, the embodiment is not limited thereto and communication with the wireless power transmission device 200 may be performed using various types of wireless communication methods.

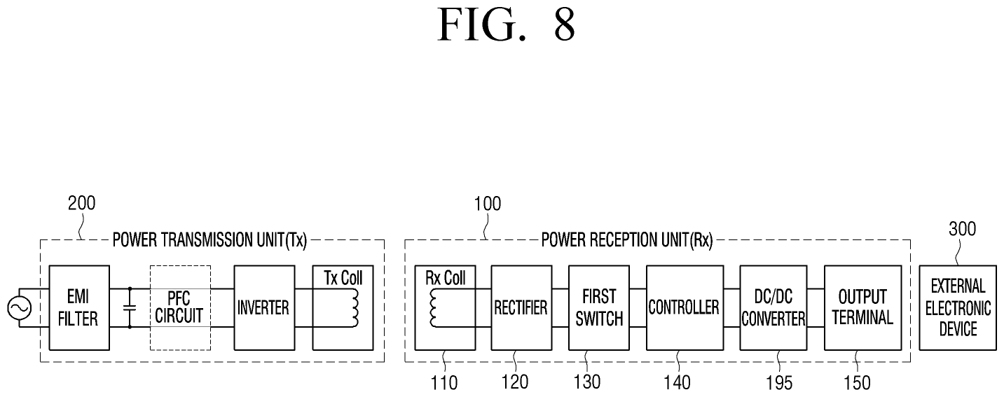

FIG. 8 is a diagram illustrating a converter according to an embodiment.

The wireless power reception device 100 according to an embodiment may include a DC/DC converter 195.

The DC/DC converter 195 may convert the power rectified by the rectifier 120 to a preset intensity. For example, the level of the DC voltage output from the rectifier 120 may be adjusted to a preset intensity. In one example, the external electronic device 300 may be implemented as a battery, and the DC/DC converter 195 may adjust the level of the DC voltage to 3-10 V according to the battery capacity. This is merely exemplary, and the DC/DC converter 195 may adjust and output a level of the voltage required for driving the external electronic device 300. The DC/DC converter 210 may output a plurality of DC power of different sizes.

The external electronic device 300 according to an embodiment may be implemented as a television (TV), a desktop, a set-top box, a sound bar, a game console, an air conditioner, a washing machine, or the like, as a related-art electronic device. When the power terminal of the external electronic device 300 is connected to the wireless power reception device 100, the wireless power transmitted by the wireless power transmission device 200 may be provided to the external electronic device 300 through the wireless power reception device 100. The external electronic device 300 may receive wireless power as the wireless power reception device 100 is connected to the wireless power reception device 100, even if a component required for receiving wireless power is not provided in a manufacturing step.

The output terminal 150 according to an embodiment may be a form capable of performing wired connection to the power terminal of the external electronic device 300. According to another example, the output terminal 150 may be a form of a connector connected to the power terminal of the external electronic device 300.

According to another example, the wireless power reception device 100 may include a DC/DC converter 195 and may output a DC voltage of a preset intensity suitable to the external electronic device 300 through the DC/DC converter 195. For example, the external electronic device 300 may be implemented as a notebook, a smartphone, a tablet, or the like, and may include a battery (or secondary battery). The wireless power reception device 100 may output a DC voltage of a preset intensity required for charging a battery, or the like, through the DC/DC converter 195. When a laptop, a smartphone, a tablet, or the like, have not been equipped with components required to receive wireless power, the wireless power reception device 100 according to an embodiment may receive wireless power and charge the battery, if connected to the wireless power reception device 100.

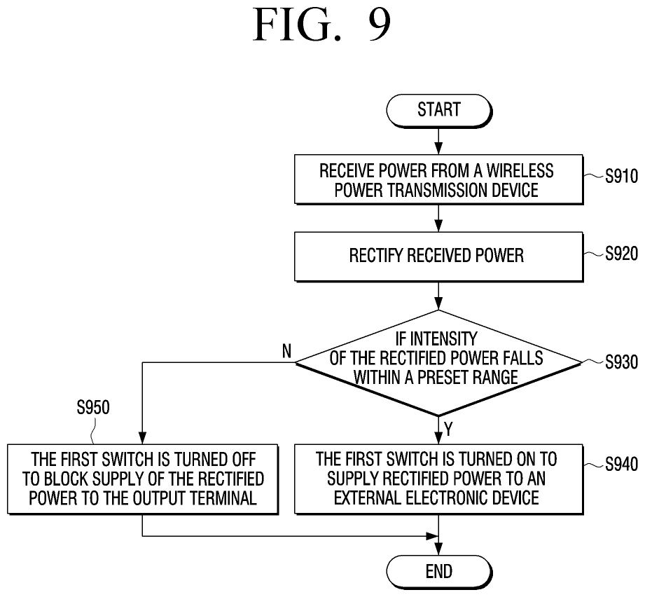

FIG. 9 is a flowchart illustrating a control method for the wireless power reception device according to an embodiment.

A reception coil receives power from a wireless power transmission device in operation S910.

Then, a rectifier rectifies received power in operation S920.

If intensity of the rectified power belongs to a preset range in operation S930-Y, a first switch is turned on to supply rectified power to an output terminal in operation S940.

If intensity of the rectified power does not belong to a preset range in operation S930-N, the first switch is turned off to block supply of the rectified power to the output terminal in operation S950.

The wireless power reception device may include a second switch provided between the rectifier and the first switch and a load connected to the second switch, and operation of S920 may include, based on the intensity of the rectified power belonging within a preset range in operation S930-Y, turning off the second switch to block supply of the rectified power to the load.

When the intensity of the rectified power does not belong to a preset range in operation S930-N, the second switch may be turned on to supply the rectified power to the load.

The wireless power reception device may include a third switch provided between the reception coil and the rectifier, and the identifying step of S920 may include identifying whether the received power is greater than or equal to a preset threshold value; blocking the received power to be supplied to the rectifier based on the received power being greater than or equal to a preset threshold value; and supplying the received power to the rectifier by turning on the third switch based on the received power being less than a preset threshold value.

The preset threshold value may be identified based on the internal pressure of the capacitor included in the rectifier.

The control method according to an embodiment may include, based on the intensity of the rectified power not belonging to a preset range in operation S930-N, transmitting information on a preset range to the wireless power transmission device.

The control method may include converting the rectified power to a preset intensity.

The output terminal according to an embodiment may be in a form capable of wireless connection to a power terminal of the external electronic device.

The output terminal according to another example may be a form of a connector that is connected to the power terminal of the eternal electronic device.

The various example embodiments described above may be implemented in a recordable medium which is readable by computer or a device similar to computer using software, hardware, or the combination of software and hardware. In some cases, embodiments described herein may be implemented by the processor itself. According to a software implementation, embodiments such as the procedures and functions described herein may be implemented with separate software modules. Each of the above-described software modules may perform one or more of the functions and operations described herein.

The computer instructions for performing the processing operations according to the various embodiments described above may be stored in a non-transitory computer-readable medium. The computer instructions stored in this non-transitory computer-readable medium cause the above-described specific device to perform the processing operations according to the above-described various embodiments when executed by the processor of the specific device.

The non-transitory computer readable medium may refer, for example, to a medium that stores data, such as a register, a cache, a memory or etc., and is readable by a device. For example, the aforementioned various applications, instructions, or programs may be stored in the non-transitory computer readable medium, for example, a compact disc (CD), a digital versatile disc (DVD), a hard disc, a Blu-ray disc, a universal serial bus (USB), a memory card, a read only memory (ROM), and the like, and may be provided.

While the disclosure has been shown and described with reference to various embodiments thereof, it will be understood by those of skilled in the art that various changes in form and details may be made therein without departing from the spirit and scope of the disclosure as defined by the appended claims and their equivalents.

1. A wireless power reception device comprising:
a reception coil configured to receive power from a wireless power transmission device;
a rectifier configured to rectify the received power;
an output terminal configured to output the rectified power to an external electronic device;
a first switch provided between the rectifier and the output terminal; and
a controller configured to identify the rectified power, turn on the first switch so as for the rectified power to be supplied to the output terminal based on intensity of the rectified power falling within a preset range, and turn off the first switch so as to block the supply of the rectified power to the output terminal based on the intensity of the rectified power not falling within the preset range.

2. The wireless power reception device of claim 1, comprising:
a second switch provided between the rectifier and the first switch; and
a load serially connected to the second switch,
wherein the controller is further configured to:
turn off the second switch so as to block the supply of the rectified power to the load based on the intensity of the rectified power falling within the preset range, and turn on the second switch so as for the rectified power to be supplied to the load based on the intensity of the rectified power not falling within the preset range.

3. The wireless power reception device of claim 1 or 2claim 1, comprising:
a third switch provided between the reception coil and the rectifier,
wherein the controller is further configured to:
identify whether the received power is greater than or equal to a preset threshold value, turn off the third switch so as to block supply of the received power to the rectifier based on the received power being greater than or equal to the preset threshold range, and turn on the third switch so as to supply the received power to the rectifier based on the received power being less than the preset threshold value.

4. The wireless power reception device of claim 3, wherein the preset threshold value is identified based on an internal pressure of a capacitor included in the rectifier.

5. The wireless power reception device of claim 1, comprising:
a communication interface,
wherein the controller is further configured to control the communication interface to transmit the information of the preset range to the wireless power transmission device based on the intensity of the rectified power not falling within the preset range.

6. The wireless power reception device of claim 1, comprising:
a converter configured to convert the rectified power to a preset intensity.

7. The wireless power reception device of claim 1, wherein the output terminal is in a form in which wired connection to a power terminal of the external electronic device is available.

8. The wireless power reception device of claim 1, wherein the output terminal is in a form of a connector that is connected to a power terminal of the external electronic device.

9. A control method of a wireless power reception device comprising a reception coil, a rectifier, an output terminal, and a first switch provided between the rectifier and the output terminal, the method comprising:
receiving, by the reception coil, power from the wireless power transmission device;
rectifying the received power by the rectifier;
identifying whether the intensity of the rectified power falls within a preset range; and
outputting the rectified power to an external electronic device by the output terminal,
wherein the identifying comprises:
turning on the first switch so as for the rectified power to be supplied to the output terminal based on the intensity of the rectified power falling within a preset range; and
turning off the first switch so as to block the supply of the rectified power to the output terminal based on the intensity of the rectified power not falling within the preset range.

10. The method of claim 9,
wherein the wireless power reception device comprises a second switch provided between the rectifier and the first switch and a load serially connected to the second switch,
wherein the identifying comprises:
turning off the second switch so as to block the supply of the rectified power to the load based on the intensity of the rectified power falling within the preset range; and
turning on the second switch so as for the rectified power to be supplied to the load based on the intensity of the rectified power not falling within the preset range.

11. The method of claim 9, wherein the wireless power reception device comprises a third switch provided between the reception coil and the rectifier,
wherein the identifying comprises:
identifying whether the received power is greater than or equal to a preset threshold value;
turning off the third switch so as to block supply of the received power to the rectifier based on the received power being greater than or equal to the preset threshold range; and
turning on the third switch so as to supply the received power to the rectifier based on the received power being less than the preset threshold value.

12. The method of claim 11, wherein the preset threshold value is identified based on an internal pressure of a capacitor included in the rectifier.

13. The method of claim 9, comprising:
transmitting information of the preset range to the wireless power transmission device based on the intensity of the rectified power not falling within the preset range.

14. The method of claim 9, comprising:
converting the rectified power to a preset intensity.

15. The method of claim 9, wherein the output terminal is in a form that wired connection to a power terminal of the external electronic device is available.
